(19) United States
(12) Patent Application Publication
(10) Pub. No.: US 2010/0011109 A1
(43) Pub. Date: Jan. 14, 2010

(54) Method for Safety Control of Data Exchange Flows Between a Communications Module and a Communications Network and Said Communications Module

(76) Inventors: Pierre Lescuyer, Montigny Le Bretonneux (FR); Thierry Lucidarme, Montigny Le Bretonneux (FR)

Correspondence Address: TROP, PRUNER & HU, P.C., 1616 S. VOSS ROAD, SUITE 750, HOUSTON, TX, 77057-2631, US

(21) Appl. No.: 10/579,575

(22) PCT Filed: Nov. 5, 2004
(86) PCT No.: PCT/EP2004/012532

§ 371 Date: Aug. 24, 2009

(30) Foreign Application Priority Data
Nov. 17, 2003 (FR) 03 13417

(51) Int. Cl. G06F 15/16; G06F 21/00

(52) U.S. Cl. 709/228; 709/232; 726/3; 726/13

(57) ABSTRACT

To perform security control for data flows exchanged between a communication module and a communication network in communication sessions organized in accordance with communication session contexts, a communication session is established with a remote unit, a corresponding communication session context is activated, and the data flows exchanged in accordance with the activated communication session context are controlled, within the established session, with respect to at least one parameter related to said context.

This invention concerns communication systems and especially communication modules.

The invention finds application in the area of communication systems, in which a data exchange service is furnished. In addition, it applies particularly well to radiocommunication systems, such as GPRS (“General Packet Radio Service”) or UMTS (“Universal Mobile Telecommunication System”), especially in the radiocommunication terminals of these systems.

The IP (“Internet Protocol”) or X.25 networks are examples of packet exchange networks, commonly known as PDNs (“packet data networks”). Each network element of a packet network is usually fitted with a controller for transmitting and receiving exchanged packets, in conformity with a PDP (“packet data protocol”). It is common to equip the controller with certain network elements of a gatekeeper system (or “firewall”), the purpose of which being to protect the network element by controlling the flow of packets transmitted or received by the network element. The firewall system filters the packets at receipt and controls the emission of packets by transmission. This system is frequently implemented within a software module that cooperates with the controller of packet transmission and receipt.

The article “Network Firewalls,” published in September 1994 by S. M. Bellovin and W. R. Cheswick in the “IEEE Communications Magazine,” supplies a detailed description of firewalls and related technologies.

The classic structure of a firewall is illustrated in FIG. 1. Two filters 1,2 enclose one or more gateways 3. Each filter 1,2 has the function of analyzing and controlling, in either a unidirectional or bidirectional manner, the packet flows exchanged over links 4 and 5. Thus, a filter is caused to reject a packet, let it pass, or ignore it on the basis of filtration criteria. The gateway or group of gateways 3 has the function of exercising application control on the data flows that the filter allowed to pass in a permitted amount. The control rules and filtration criteria are defined and configurable by means of a configuration module 6 connected to each of the firewall components 1, 2, 3.

For example, the filtration criteria can, in a known manner, be defined on the basis of the source or destination address or on the basis of the destination or source service of the packets to be filtered. In the case of a firewall operating with TCP/IP or UDP/IP packets, this may involve the source or destination IP address of a datagram or the source or destination UDP or TCP port of a UDP or TCP packet. Thus, a filter 1, 2 can be configured so as to prevent passage by TCP packets to a data port number, corresponding to a determined service.

The gateway or group of gateways 3 serves as a control in connection with one or more criteria related to a data application. A typical example consists of, in the case of an email exchange application, a filtration application for exchanged emails that operates on the basis, e.g., of information that is detected in the heading or body of the email.

In general, filter 1 is bidirectional and configured so as to protect the equipment downstream, amongst which is found the gateways 3, filter 2, and the equipment connected with link 5, and it affects the flows of data exchanged through link 4. Filter 2, which is also bidirectional, furnishes supplementary protection to the equipment connected with link 5.

Most often, the network nodes, such as the gateways, routers, or bridges, are equipped with a firewall. Notably, this permits isolation of a private network (e.g., a business's network or an intranet) or a public network (typically, the Internet) to which it is connected. Firewalls are thus largely used in the context of interconnected networks. They are also used vis-a-vis personal computers equipped with average software and hardware for Internet connection, whether directly or by means of an intermediary (i.e., an “Internet Service Provider” or ISP). A user can therefore equip his personal computer with firewall software so as to protect it while connected to the Internet.

In fact, it is possible to envision equipping any system, which is capable of data exchange with a data communication network, with a firewall like that shown in FIG. 1. This was raised in international patent WO 03/017705, which dealt with the integration of a multiplicity of software applications within a radiocommunication terminal, amongst which was a firewall application that works with a packet filtration unit.

In addition, Patent EP 1 094 682 contemplates a mobile telephone or a mobile access unit that communicates with a packet exchange network that includes a security function guaranteed, for example, by a security gateway.

The use of firewalls in the context of radiocommunication networks has also been the subject of an article titled “Firewalls for Security in Wireless Networks” (Murthy et al., Proceedings of the Thirty-First Hawaii International Conference on System Sciences, 1998, Volume: 7 , 6-9 Jan. 1998), in which the authors described a system where a firewall was placed into operation within the infrastructure of a radiocommunication network.

The major inconvenience of proposed solutions is that they do not permit the placement of a security function into operation within a mobile station that is adapted to the diversity of communication networks with which a mobile station is responsive during data exchange. In effect, they do not offer, security functions that act, without distinction, as to the whole of the data flows exchanged by a mobile station. This problem, which is not exclusively specific to radiocommunication systems, also arises in the more global context of placing a security function into operation within communication equipment susceptible to the simultaneous exchange of data with communication networks that may be adapted to the diversity of the security conditions desired during an exchange of data with each of these networks.

The aim of this invention is the proposal of a new architecture that is optimal for the security function within communication equipment but that does not present the inconveniences described above.

The invention therefore envisions a communication module comprised of methods to exchange data flows with a communication network, within the framework of communication sessions established and organized per with the communication session contexts, and of security methods to control the exchanged data flows. The security methods that control the exchanged data flows are mechanisms operating in connection with at least one parameter attached to the communication session context of the corresponding session.

Per the invention, the security methods controlling the exchanged data flows perform a security function that is organized within a communication module and that acts within the framework of a communication session, on the basis of the associated communication session context. This solution permits the placement of a security function into operation within a framework more specific than that of a simple data exchange.

Per the invention, the security methods controlling the exchanged data flows can be organized so as to operate in connection with a communication session's context key of the corresponding session and/or with a constituent parameter of such context. Examples of parameters usable within the invention's framework are an address which can be that of the module, per the invention, or of equipment within which it is incorporated, the service quality associated with the exchange of data flows, or the target network's key.

Advantageously, the methods of exchanging data flows include methods of exchanging packet data flows, and the security methods controlling the data flows are laid out so as to operate on the packet data.

More specifically, the security methods controlling exchanged data flows can be structured on the basis of the classic structure of a firewall, as described supra. They can thus include a filter that operates on the data flows, in connection with at least one parameter attached to the communication session context of the corresponding session.

The security methods controlling the exchanged data flows can take an alternative form, including first and second filters that operate on the exchanged data flows and one or more gateways controlling the data flows exchanged in connection with one or more criteria related to a data application, at least one of the first and second filters therefore being laid out so as to operate in connection with at least one parameter attached to the communication session context of the corresponding session.

The invention finds particularly advantageous application in the field of radiocommunications. Thus, per the invention, one envisions integration of the module into a radiocommunication module or radiocommunication infrastructure equipment. Typically, the radiocommunication module will be incorporated into a mobile station.

Moreover, the invention contemplates a procedure to effectuate security control over the data flows exchanged between a communication module and a communication network during communication sessions organized per the communication session contexts, in which a communication session is established with a remote correspondent (often, an active communication session context) and in which the exchanged data flows are controlled per the activated communication session context, in connection with at least one parameter attached to such context. This procedure will be advantageously applied to packet data flows.

Per the invention, the control of exchanged data flows can operate in connection with a communication session's context key of the corresponding session and/or with a constituent parameter of such context.

Consequently, it is possible to envision the control of data flows exchanged per the active communication session context, as it conforms to the invention's process for filtering such data flows through at least one filter that operates in connection with at least one parameter attached to the communication session context of the corresponding session.

Alternatively, the step of controlling the data flows exchanged per the active communication session context may be placed into operation by filtering such data flows through at least first and second filters (filtering the exchanged data flows), as well as one or more gateways to control the data flows exchanged in connection with one or more criteria related to a data application, at least one of the first and second filters therefore being laid out so as to operate in connection with at least one parameter attached to the communication session context of the corresponding session.

Finally, the invention offers a computer program, storable in memory, that is associated with a processor and that includes instructions for the placement into operation of a process (such as that defined above) during execution of the program by the processor, as well as storage media on which the program is recorded.

Other particularities and advantages of this invention are described below in the examples of non-limitative realizations, vis-a-vis the attached designs, of which:

FIG. 1 is a synoptic diagram of the classic firewall structure;

FIG. 2 is a diagram that illustrates a communication system, including a mobile station that incorporates a module per this invention; and

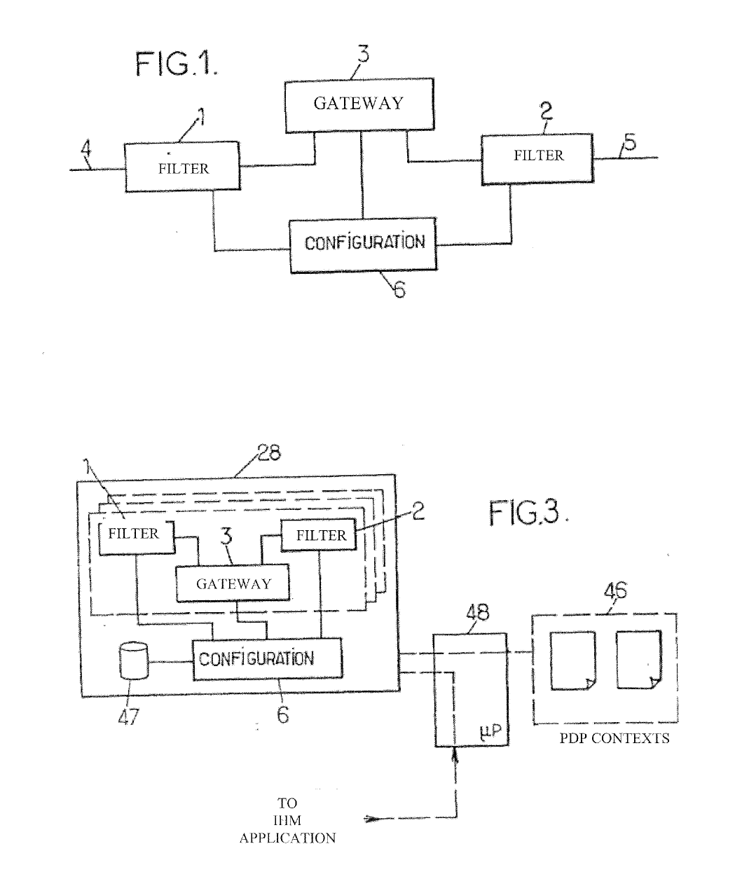

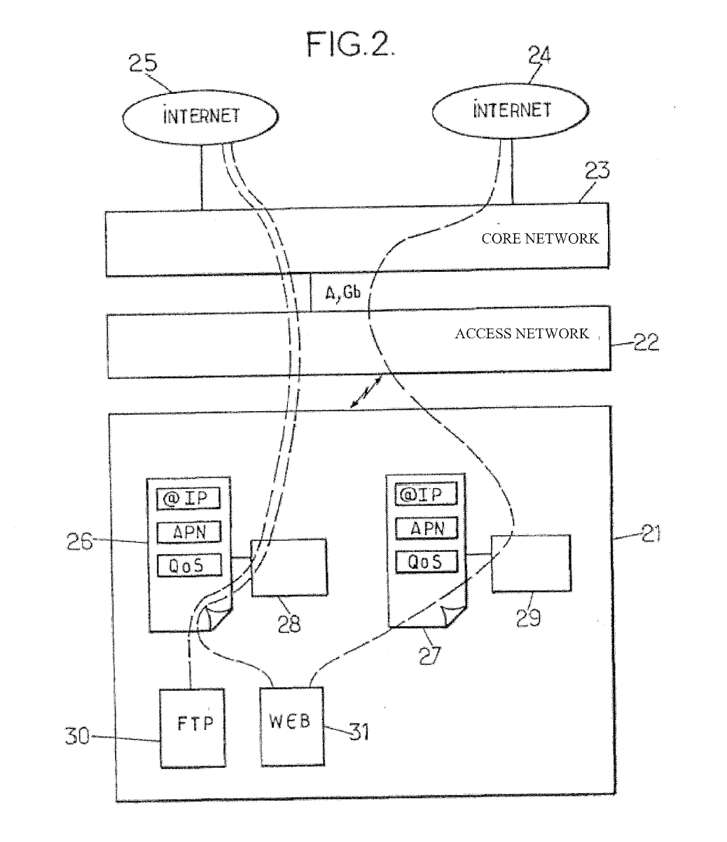

FIG. 3 illustrates an architectural example of a module per this invention.

The invention will be described below within the non-limitative framework of radiocommunication systems, which furnishes a particularly pertinent example of its placement into operation.

FIG. 2 illustrates the placement into operation of the invention within a mobile station 21 in communication with two networks 24, 25, with one being a public network and the other being a private network.

Communications, particularly data exchanges, are carried out on the basis of a radiocommunication network (e.g., a PLMN or “Public Land Mobile Network”). Classically, this PLMN is divided into a core network 23, comprised of interconnected switches, and an RAN (“Radio Access Network”) 22 that provides the radio links with the mobile stations 21.

In the example shown, the PLMN is a second generation GSM network. It incorporates, in this case, a GPRS (“General Packet Radio Service”) packet transmission service. In the GSM, the access network 22, called a BSS (“Base Station Sub-system”), is composed of base transceiver stations (BTS) distributed over the network coverage area, in order to communicate via radio (Um interface) with mobile stations 21, and of base station controllers (BSC), which are connected to the core network 23 and which monitor each of the base stations through so-called Abis interfaces. The protocols used in the GPRS PLMN are described in the following GSM technical specifications: 23.060 (version 5.6.0, Release 5, July 2003), 03.64 (version 8.9.0, Release 1999, November 2002), 08.16 (version 8.0.1, Release 1999, July 2002), and 29.061 (version 5.7.0, Release 5, October 2003), published by the 3GPP (“Third Generation Partnership Project”).

The invention is applicable to other types of PLMNs, especially to third-generation UMTS (“Universal Mobile Telecommunications System”) or CDMA 2000 networks.

Per UMTS standards, the core network includes two different domains corresponding to a distinction between CS (“Circuit Switched”) and PS (“Packet Switched”) services. Therefore, the PS domain is distinguished from the CS domain. Thus, certain functions, especially call completion, are administered differently and carried out through different core network equipment, depending on which of the two domains they were executed in.

The core network 23 is linked to the radio access network 22 through at least one interface, named interface A, Gb for the GSM, and Iu for the UMTS.

Furthermore, the core network 23 is linked to fixed networks comprised of one or more packet data transmission networks, using the respective protocols (PDP), such as X.25 or IP. In the example illustrated by the designs, there is a public packet transmission network 25 constituted by the Internet and a private packet transmission network 24 constituted by an Intranet network.

For the packet mode, the core network 23 includes GSN (“GPRS Support Node”) switches, which communicate amongst themselves through a Gn interface. The packet switches linked to the BSC of the access network 22 are called SGSNs (“Serving GSNs”), while the other packet switches, named GGSNs (“Gateway GSNs”) serve as gateways with the packet networks, especially the Internet 25 and the Intranet network 24. These gateways are linked to the SGSNs in order to permit the mobile stations 21 to access the networks 24, 25.

The call completion process within the PS domain of the UMTS or within the GPRS packet switched network involves the concept of PDP contexts. A PDP context is a distinctive example of a communication session context, in that one can define it as a set of information related to a communication session.

The concept of PDP contexts is described in paragraph 7.2.1 of P. Lescuyer's reference work: “UMTS, Les origines, L'architecture, La norme” (UMTS, the Origins, the Architecture, the Standard”) (2^{nd} edition, Dunod, 2002). The PDP context gathers the set of information, permitting the transmission of user data between the mobile, the UMTS network, and the external packet switched network (e.g., the Internet).

Before initiating any data transfer, the mobile station 21 must necessarily request that the core network 23 activate a PDP context, which must verify the conformity of the requested context's attributes against the subscription characteristics selected by the user.

Several PDP contexts can be simultaneously active for a data user. The user may, in effect, want to activate several parallel sessions (for example, in order to simultaneously have two windows for emails detained by two different service providers). In such a case, the mobile must activate as many PDP contexts as there are sessions. In theory, this functionality allows a user to simultaneously navigate the Internet by using the WAP (“Wireless Application Protocol”) on his GPRS mobile telephone and visit a website on his computer, which is connected to the mobile telephone, via activation of the two PDP contexts.

Two communication session contexts 26, 27 are activated within the mobile station 21. In the example illustrated by the designs, it takes the form of two active PDP contexts. Each PDP context is connected to the network with which one wishes to initiate a communication session: the mobile station 21 to an active communication session with the intranet network 24 and two active communication sessions with the public Internet 25.

The activation process for a PDP context by a mobile station is described in detail within paragraph 9.2.2.1 of 3GPP's TS 23.060 specification.

To start this process, the mobile station sends an activation message (ACTIVATE PDP CONTEXT REQUEST) to the SGSN. This message indicates the values of the different parameters of the PDP context required for completion, of which the principal ones are the following:
the PDP address of the mobile station 21. In the case of the external Internet, it takes the form of an IPv4 or IPv6 address. For each ongoing PDP context 26, 27, the mobile station therefore allocates a temporary IP address;
the service quality associated with the communication, which is represented by the radio link attributes allocated by the access network 22;
the APN (“Access Point Name”), which corresponds to the fixed network key 24, 25, to which the mobile desires access.

As indicated above, several PDP contexts can be simultaneously active so that a mobile station may simultaneously have several distinct PDP addresses (typically, several source IP addresses). As a result, the invention permits, for example, the placement into operation of a security function that operates independently on each of the flows exchanged with multiple source IP addresses.

Per the invention, the activation of each communication session context 26, 27—in the illustrated example, each PDP context—gives rise to the creation of a software security task 28, 29 that furnishes the firewall functions described above, and this activation operates within the framework of exchanges performed in accordance with the context 26, 27 with which it is associated. Each software security task 28, 29 is, in effect, susceptible to the performance of an operation on the data flows exchanged within the framework of a communication session defined in the corresponding context 26, 27. For example, filtration parameters contingent upon IP addresses and/or TCP or UDP ports of datagrams received or sent will differ in accordance with that which acts as the communication context 26 with the Intranet network 24 (or the communication context 27 with the Internet 25). Notably, one might desire to set the parameters of the software security task 28 in such a way as to furnish heightened security for access to the public Internet (conveyance through more restrictive active filtration parameters), in comparison to setting parameters for a software security task 29 vis-a-vis Intranet access where it would be impossible to disturb the execution of applications peculiar to the private network, which offers better security by its very nature.

For example, a business can tolerate the fact that its employees globally “navigate” the public Internet through the intermediary of their mobiles and thus authorize incoming and outgoing transactions on port 80, which is traditionally reserved for exchanges per the HTTP (“HyperText Transfer”) protocol. A business can explicitly forbid access to certain sites contrary to its sense of ethics, if it so desires, by means of security regulations. Furthermore, it can, in controlling port 25, which is dedicated to the SMTP (“Simple Mail Transfer protocol”) for the two communication sessions, authorize the sending (or the receipt) of emails to (or originating from) the Intranet and refuse the sending (and/or the receipt) of emails to (or originating from) the Internet.

Each software security task 28, 29 is therefore appropriate for controlling and, especially, limiting the data flows exchanged by the mobile station 21 in connection with any of the parameters attached to the context 26, 27 which which it is associated, especially one of the constituent parameters of such context 26, 27, as, for example, in the case of the PDP context represented in FIG. 2, the address (PDP) of the mobile station 21, the service quality connected with the communication, or the APN. Flow control can also be carried out on a more global scale than that of the context 26, 27 in itself (for example, on the basis of a context 26, 27 key). This allows the exercise of control over the whole of the flows exchanged within the framework of a session organized per a context 26, 27, on the basis of its key, contrary to the flows exchanged within the framework of a session organized per another context 26, 27 for which one chooses to not effectuate control.

Two application software tasks 30, 31—one dealing with the transfer of files per the FTP protocol and the other dealing with the lookup of web pages—exchange data (the logical path of which is represented by dotted lines in the figure) with corresponding entities within the fixed networks 24, 25 on the basis of active contexts 26, 27.

Organization of the functions carried out by the software security tasks 28, 29 used within the mobile station 21 can correspond to the structure of the firewall described above and illustrated in FIG. 1. It is also possible to contemplate a more streamlined organization within the framework of the invention, i.e., incorporating only filters or even just one filter. Moreover, the security function can be configured so that each filter operates in a unidirectional or bidirectional manner. In effect, the invention is not limited to a specific organization for the security function.

FIG. 3 illustrates an example of model architecture per the invention. The security module 28 includes one configuration module 6 linked to memory 47, in order to record the security parameters associated with various PDP contexts. The module 28 furnishes a security function that is activated on the basis of the instantiation of software tasks offering the filtration 1, 2 and 3 control functions previously described as being under the control of an entity 48 typically constituted by a processor.

Moreover, the controller 48 drives a set 46 of PDP contexts. It proceeds from the activation of a context to the management of active contexts and, if necessary, to their closing. The set 46 consists, for example, of memory in which is stored the different parameters of each PDP context particular to the user making use of the module per the invention. Following the invention, during activation of a PDP context, the controller 48 also drives the module 28 so as to create an occurrence where the software security task operates per the parameters connected with the context of which one required activation. The values of these parameters are configured first and consigned to memory 47. The software security task thus created is eliminated during the closing of the PDP context, the activation of which gave rise to the task's creation.

In one of the invention's supplementary operational modes, the firewall's configuration module 6 can be organized so that either the whole or a portion of the parameters consigned to memory 47 may be accessible at configuration to the user. To this end, the module 6 works with the person-machine interface application of the user's terminal on the basis of the controller 48. Advantageously, it is possible to contemplate how this configuration option offers a GUI (“Graphical User Interface”) to the user.

The user can thus configure the parameters of the software security tasks which will be created following activation of a given PDP context. One can also envision the possibility of defining the parameter sets for the software security task connected with a type of network (public network, private network for example) with which the user is susceptible to data exchange.

The invention therefore contemplates the possibility of defining parameter sets, stored in memory 47, on the basis of a graphical user interface (GUI). By definition of a parameter set available at configuration for the software security task, one means the possibility of the user selecting the parameter(s) that he wishes to configure, attributing the desired values to the chosen parameters. A graphical user interface will allow the user to easily create, modify, or eliminate the security profiles connected with the communication session contexts.

In another mode of operation, the invention is placed into operation within infrastructure equipment of a radiocommunication network. The invention thus permits, for example, the filtration of flows exchanged by communication session contexts connected with the subscription user attributes. For an operator, this translates into the possibility of placing into operation, for example, a filter of non-solicited, commercial emails (“spam”) or a virus filter for privileged users, without necessarily offering this service to other users. In the framework of GPRS or UMTS radiocommunication networks, the communication session contexts are PDP contexts. In the example shown in FIG. 2, the radiocommunication network infrastructure includes the radio access network 22 and the core network 23. The placement of the invention into operation within a GGSN switch of the core network, for example, has shown itself to be particularly advantageous. On the one hand, because a GGSN (and an SGSN) has knowledge of active PDP contexts, it essentially stores a table of PDP contexts, which is especially used to manage invoicing. For more details, consult the descriptions of procedures for activation, modification, and deactivation of PDP contexts, as found in paragraphs 9.2.2, 9.2.3, and 9.2.4 of the 3GPP TS 23.060 specification, version 5.6.0. Per the invention, it is therefore possible to connect a communication module to a GGSN. On the other hand, because the GGSN, which serves as a gateway bordering the core network, is an anchorage point for communications, in view of the PLMN, there is no GGSN transfer during a communication session, thus being more effective in exercising control over data flows, per the invention, starting from this node of the core network.

It is understood that the module, per the invention, in its different modes of operation, can be implemented in different ways (e.g., as an electronic map designed to be placed on a semiconductor as an ASIC (“Application Specific Integration Circuit”) or within radiocommunication terminal equipment or infrastructure equipment), without taking away from the invention's generality.

1. A communication module comprised of methods to exchange data flows with a communication network with the communication session framework established and organized per the communication session contexts (26, 27) and of security methods (28, 29) for the control of exchanged data flows, which are characterized by the fact that such security methods (28, 29) for the control of exchanged data flows are organized so as to operate in connection with at least one parameter attached to the communication session context (26, 27) of the corresponding session.

2. Per claim 1, a module in which the security methods (28, 29) for the control of exchanged data flows are organized so as to operate in connection with a communication session context key (26, 27) of the corresponding session.

3. Per claim 1, a module in which the security methods (28, 29) for the control of exchanged data flows are organized so as to operate in connection with at least one constituent parameter of the communication session context (26, 27) of the corresponding session.

4. Per claim 3, a module in which such parameter is an address of the module or of equipment within which it is incorporated, a service quality associated with the data flows exchanged, or the target network's key.

5. Per claim 1, a module in which the methods to exchange data flows include methods to exchange packet data flows, with the security methods for the control of data flows being organized so as to operate on the packet data.

6. Per claim 1, a module in which the security methods (28, 29) for the control of exchanged data flows includes a filter (1, 2) that operates by filtration on the data flows.

7. Per claim 1, a module in which the security methods (28, 29) for the control of the exchanged data flows includes first and second filters (1, 2), which operate by filtration on the exchanged data flows, and one or more gateways (3) for the control of the data flows exchanged in connection with one or more criteria related to a data application, in which at least one of the first and second filters is a mechanism operating in connection with at least one parameter attached to the communication session context of the corresponding session.

8. A radiocommunication module, including a communication module per part of claim 1.

9. A mobile station (21) capable of data exchange with a radiocommunication network (22, 23), including a radiocommunication module per claim 8.

10. Infrastructure equipment of a radiocommunication network, including a communication module per part of claim 1.

11. A process to carry out security control for data flows exchanged between a communication module and a communication network during the communication session organized per communication session contexts, in which:
a communication session is established with a remote correspondent, often an active communication session context; and
one controls, within the established session, the data flows exchanged per the active communication session context, in connection with at least one parameter attached to such context.

12. Per claim 11, a process in which one controls the data flows exchanged per the active communication session context, in connection with a key of such active context.

13. Per claim 11, a process in which one controls the flows of data exchanged per the active communication session context, in connection with at least one constituent parameter of such active context (26, 27).

14. Per claim 13, a process in which such parameter is a module address, a service quality associated with the exchange of data flows, or the target network's key.

15. Per claim 11, a process in which one controls the packet data flows exchanged per the active communication session context, in connection with at least one parameter attached to the communication session context of the corresponding session.

16. Per claim 11, a process in which one controls the data flows exchanged per the active communication session context by filtering such data flows through at least one filter operating in connection with at least one parameter attached to the communication session context of the corresponding session.

17. Per claim 11, a process in which one controls the data flows exchanged per the active communication session context by filtering such data flows through at least first and second filters, in order to filter the exchanged data flows, and one or more gateways controlling the data flows exchanged in connection with one or more criteria related to a data application, at least one of the first and second filters being organized so as to operate in connection with at least one parameter attached to the communication session context of the corresponding session.

18. A computer program, storable in memory, that is connected with a processor and that includes instructions for the placement into operation of a process, per part of claim 11, during the execution of such program by the processor.

19. Storage media on which the program, per claim 18, is recorded.
